(19) United States
(12) Patent Application Publication
(10) Pub. No.: US 2004/0130888 A1
(43) Pub. Date: Jul. 8, 2004

(54) Head lamp

(76) Inventor: Harald Twardawski, Rastatt (DE)

Correspondence Address: HARNESS, DICKEY & PIERCE, P.L.C., P.O. BOX 828, BLOOMFIELD HILLS, MI, 48303, US

(21) Appl. No.: 10/718,502

(22) Filed: Nov. 20, 2003

(30) Foreign Application Priority Data
Nov. 22, 2002 (DE) 102 54 630.4

(51) Int. Cl. F21V 21/084

(52) U.S. Cl. 362/105; 362/184; 362/800

(57) ABSTRACT

A head lamp includes a lamp head for the reception of a light source which has two lugs which are arranged at opposite sides, are connected to the lamp head and to which an elastic headband of the head lamp can be fastened for the fastening of the head lamp to the head of a person and which are so flexible that their shape is adaptable to the shape of the head by the tension of the headband on being secured to the head.

### CROSS REFERENCE TO RELATED APPLICATION

This application claims priority to German Patent Application No. 102 54 630.4, filed Nov. 22, 2003, which is hereby incorporated by reference herein.

### FIELD OF THE INVENTION

The present invention relates to a head lamp.

### BACKGROUND OF THE INVENTION

Head lamps are generally known and are frequently used in activities in which a field of vision of a user has to be illuminated, but the user simultaneously needs his hands for other work. Typical applications are, or example, speleology, mountain sports, running training or even repair work, for example on motor vehicles, at night.

Such head lamps frequently have a rigid carrier element at which the actual lamp head is held or which is integrated into the lamp head. An elastic headband is then fastened to this carrier element and the user pulls it over his head to fasten the head lamp to the head. The lamp head is then pulled against the forehead of the user by the carrier element by the tension in the elastic headband and is held by this tension in a more or less stable position relative to the forehead and so to the head of the user. The carrier element is frequently formed by a plate whose dimensions approximately correspond to those of the lamp head.

However, such head lamps have a series of disadvantages. To ensure a reliable positioning of the lamp head at the forehead, it is necessary to select the tension in the headband to be relatively high so that the carrier element is pulled toward the forehead of the user with a correspondingly high force. However, this can result in an unpleasant feeling of pressure on the forehead, which can be very unpleasant, in particular with a use over a long period.

Such head lamps can furthermore not be held securely enough in the intended position at the forehead under certain circumstances due to the mass of the lamp head on very fast movements of the head without disproportionately increasing the tension exerted by the headband.

### SUMMARY OF THE INVENTION

It is therefore the underlying object of the current invention to provide a head lamp which can also be worn pleasantly over a longer period of time with a simultaneously good fit on a head of a user.

The object is satisfied by a head lamp having the features of claim 1.

The head lamp in accordance with the invention includes a lamp head for the reception of a light source, the lamp head having two lugs which are arranged at opposite sides and connected to the lamp head and to which an elastic headband of the head lamp can be secured for the fastening of the head lamp to the head of a person and which are so flexible that their shape is adaptable to the shape of the head by the tension of the headband on being secured to the head.

The lamp head of the head lamp in accordance with the invention serves for the reception of at least one light source by means of which light can be produced which can then be transmitted as a light beam from the lamp head. This light source can, for example, be an incandescent lamp, a halogen lamp or also a krypton lamp, with light emitting diodes, however, preferably being used which have a lower energy absorption compared to the transmitted light output than the previously named light sources. One or more light sources can be provided in the lamp head.

An image producing device, for example a reflector and/or a lens, by means of which the light beam of the lamp head can be formed by the light source, can be provided in the lamp head for the provision of a light beam. If a plurality of light sources are used, a common image forming device, for example a reflector can be used for some of the light sources, or a separate image producing device, for example a lens, can also be provided for each light source.

Two lugs are formed at the lamp head, for the holding thereof, which are arranged at opposite sides of the lamp head, are connected to the lamp head and to which an elastic headband of the head lamp can be fastened. These lugs, which extend away from the housing in opposite directions, are so flexible that their shape is adaptable to the shape of the head by the tension of the headband on being secured to the head of a user. The tension in the headband is influenceable by selection of the module of elasticity of the band material and of the width and of the length of the headband with only a low dependency on the head size of the user.

The lugs are at least partly pulled toward the forehead of the user, preferably at their free ends, by the tension in the elastic headband, which expediently has a smaller circumference than the head of a user, and then at least partly contact it. The flexibility required for the at least part deformation of the lugs on a desired minimum tension of the headband can be influenced by the choice of the material and of the shape, and in particular of a cross-section, of the lugs.

The lamp head is therefore not only pulled toward the head of a user at a contact region between the lugs. The preferably areally formed lugs rather also serve at least partly as further contact areas so that, on the one hand, no large force has to be transmitted via the contact area lying between the lugs and the tension in the elastic headband can be kept smaller. This increases the wearing comfort for a user. In particular, pressure peaks will occur less easily which could impair the wearing comfort.

Furthermore, only small forces to be transmitted to the head occur at the ends of the lugs when a rotational torque is applied to the lamp head since the lugs project to the side from this and thus each form a kind of lever at whose ends only comparatively smaller forces act. Only smaller forces have to be transmitted to the head due to this geometry which is favorable with respect to other fastening arrangements such that the tension of the headband can be kept comparatively low. This in turn increases the wearing comfort for a user.

Due to the good fixing of the lamp head of the head lamp in accordance with the invention to the forehead of a user, batteries for the supply of the light sources therein can generally be arranged in the lamp head. However, to better distribute the weight of the head lamp and in particular also to keep the dimensions of the lamp head low, it is preferred for a battery holder to be provided having two lugs which are arranged at opposite sides of the battery holder and are connected thereto and to which the headband can be fastened and which are so flexible that, when fastened to the head, their shape is adaptable to the shape of the head by the tension of the headband. The battery holder can be connected to the lamp head by a corresponding connection cable, particularly preferably by a partly coiled connection cable. The comparatively heavy batteries can thereby, for example, be carried at the back of the head of a user so that a better weight distribution at the head of the user results. Furthermore, it is also possible more easily to protect the battery holder, and thus batteries held therein, against cold, in that, for example, the battery holder held at the back of the head is covered by a cap or by a hood. By this fastening of the battery holder by the lugs in an analog manner as with the lamp head, the same advantages result with respect to the wearing comfort and to the stable fixing of the battery holder at the head of the user.

To achieve a support at the head of a user which is as wide as possible and which allows a particularly secure seat of the head lamp, it is preferred for the free ends of the lugs to have a spacing of at least 7 cm.

To achieve good wearing comfort, a wide headband is usually used since hereby a given force can be distributed over a larger surface and the pressure acting on the head of the user can be reduced. It is therefore preferred for the lugs each to have slot-like openings through which the headband can be guided. In this manner, a wide headband can also be easily fastened to the lugs. It can in particular only be pushed through the slot-like openings to then be connected to other parts of the lamp head or, if present, of the battery holder or to its ends. If a height of the opening is particularly preferably selected in accordance with the width of the headband, such that substantially a shape matched arrangement results between the headband and the opening when this is introduced into the slot-like opening, a particularly favorable force transmission results between the lug and the headband, whereby a particularly secure positioning of the lamp head is made possible. The slots are particularly preferably formed with a large slot depth in an areal region of the lugs. A good force transmission onto the headband and a large contact surface of the lug at the head thereby results.

It is furthermore preferred for the lamp head and/or the battery holder to have a housing which is at least partly surrounded by a jacket of an elastic material at which the lugs are formed. The housing is preferably formed of a rigid material which is not deformed, or which is only slightly deformed, with the forces occurring under normal use. In the case of the lamp head, the housing can serve for the reception of the light source and can furthermore receive or also include the aforesaid image producing devices. In the case of the battery holder, the housing can include a compartment for one or more batteries or for a rechargeable battery which can be covered by a moving cover. The jacket, preferably made in once piece, expediently contacts the housing at least partly so tightly that a good transmission of forces normally occurring on the wearing of the head lamp in accordance with the invention between the housing and the jacket is possible without substantial relative movement between the housing and the jacket.

In this manner, flexible lugs can be made available very easily at the lamp head or at the battery holder which can nevertheless be rigid in the region of the housing. In particular, fastening apparatuses can thereby be avoided by means of which the lugs can be fastened to a housing of the lamp head or of the battery holder, for example, hinges. Furthermore, the jacket can serve as protection against shocks. The jacket only needs to partly surround the housing and can, for example, have an opening through which light can be radiated, in the case of the battery compartment, or through which a battery can be inserted into a battery compartment in the case of the battery holder. It is furthermore particularly preferred for the jacket to have an opening in a region in which the housing contacts the head of the user since in this manner the contact region can be designed independently of the properties of the elastic jacket. It is, however, particularly preferred, in particular with the lamp head, for the jacket to completely surround the housing, with the exception of openings for the radiation of light, at regions which, on use by a user, do not contact his forehead. In this manner, the jacket can also serve as a sealing of the housing against water penetrating from the outside. If the battery holder has a lower part of a battery housing and a cover pivotably supported at the lower part of a battery housing, it is particularly preferred for the jacket to surround the lower part of the battery housing such that it simultaneously takes over the function of a seal between the lower part of the battery housing and the battery holder cover.

The material can generally be formed from any desired elastic material whose elasticity only has to be so large that the lugs can be matched to the head shape of a user by the tension of the headband. It is, however, preferred for the jacket to be made from an elastomeric material. Such materials are characterized by a high extensibility and can have lower moduli of elasticity in comparison with other polymers such that a deformation is possible with only small forces, i.e. tensions, in the headband.

To manufacture the housing and the corresponding jacket, it is particularly preferred for the jacket to be made from a thermoplastic, elastomeric material and for the housing to be made from a further thermoplastic material. In particular polyurethanes of a suitable composition can be used as thermoplastic elastomeric materials. The further thermoplastic material can in particular be plastics which have a high modulus of elasticity in comparison with typical thermoplastic elastomers. The housing and the corresponding jacket can then preferably be manufactured by means of a method having the features of claim 12 which is likewise a subject of the invention. In the method in accordance with the invention for the manufacture of the housing and of the corresponding jacket for a head lamp in accordance with the invention, the jacket and the housing are manufactured by two-component injection molding of a thermoplastic elastomeric material and of a further thermoplastic material. In this manner, the housing and the jacket cannot only be manufactured very easily, in particular on a suitable design in one step, but there also results a particularly good shape matched connection between the jacket and the housing such that a largely uniform transmission of force between the jacket and the housing is made possible. Furthermore, a high sealing tightness can thus be achieved since the jacket contacts the jacket very tightly.

It is furthermore particularly preferred for a switch to be arranged in the housing which is covered by the jacket and which can be operated by pressure on the jacket. The switch can be arranged in the housing of the battery holder or, preferably, for reasons of more simple operation, in the lamp head. The switch is thereby protected from moisture or wetness and therefore does not have to have any corresponding seal, which reduces the overall costs or the overall manufacturing effort for the lamp head.

It is furthermore particularly preferred for at least one lens to be formed in a wall of the housing of the lamp head as an image producing device for the forming of a light beam transmissible from the lamp head of light of a light source held in the lamp head and for a corresponding opening to be provided in the jacket. This type of construction substantially simplifies the manufacture of the lamp head since the image producing devices do not need to be manufactured separately and then fastened to the housing, but are formed in one piece therewith. In particular a more precise adjustment of the image producing elements in the housing results. Furthermore, in particular with a joint manufacture of the jacket and of the housing, an alignment of the openings in the jacket to the lens is substantially simplified.

To enable the head lamp also to be adapted to users with different slopes of the forehead, it is preferred for the lamp head to have a housing for the reception of at least one light source and an areal support element held at the housing which is pivotable in a plane relative to the housing which is substantially aligned orthogonally to a surface of the support element. In this manner, the inclination of the housing, and thus of the lamp head with a light sourcee held therein, can be adapted to the individual head shape of a user such that a light beam transmitted from the lamp head can be easily set to the normal direction of gaze of the user. Due to the flexibility of the lugs, which can in particular be twistable, a high wearing comfort can furthermore be achieved with a simultaneously reliable fixing of the lamp head to the forehead of the user. When a jacket is used which at least partly encloses the housing, the jacket has an opening, particularly preferably in the region of the support element, in which the support element is pivotable and which is substantially coverable in at least one position by the support element. In this manner, the support element can be pivotable over a large region without being impaired by the presence of the jacket.

It is preferred for latch elements to be arranged at the housing of the lamp head and at the support element which are complementary to one another and by means of which the support element can be secured in its relative position to the housing. In this manner, a once-made matching of the position of the support element relative to the housing to the slope of the forehead of a user can be secured very easily such that a repeated setting is not necessary.

If a lamp head is used which has a jacket, it is particularly preferred for one of the latch elements to be movable by pressure on a pre-determined region of the jacket of the lamp head and for the latching of the latch elements thus to be able to be cancelled. In this manner, latch elements penetrating through the jacket can be avoided such that a sealing function of the jacket with respect to the housing is not impaired. Furthermore, a more pleasing appearance of the lamp head also results.

For the latching of the support element in a pivot position, there can in particular be provided a toothed rack having a plurality of latch teeth as latch elements and a resilient arm having a region projecting with respect to the arm as a complementary latch element which can be latched between two of the latching teeth.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of a head lamp in accordance with a preferred embodiment of the invention;

FIG. 2 is a side view of a lamp head of the head lamp in FIG. 1;

FIG. 3 is a schematic sectional view through the lamp head in FIG. 2;

FIG. 4 is a plan view of a tube body of the lamp body;

FIG. 5 is a side view of the lamp head in FIG. 2 with a support element pivoted out;

FIG. 6 is a schematic sectional view through a housing rear wall and the support element of the lamp head in FIG. 5; and

FIG. 7 is a schematic sectional view through a battery holder of the light source in FIG. 1.

### DETAILED DESCRIPTION OF THE PREFERRED EMBODIMENTS

The following description of the preferred embodiment(s) is merely exemplary in nature and is in no way intended to limit the invention, its application, or uses.

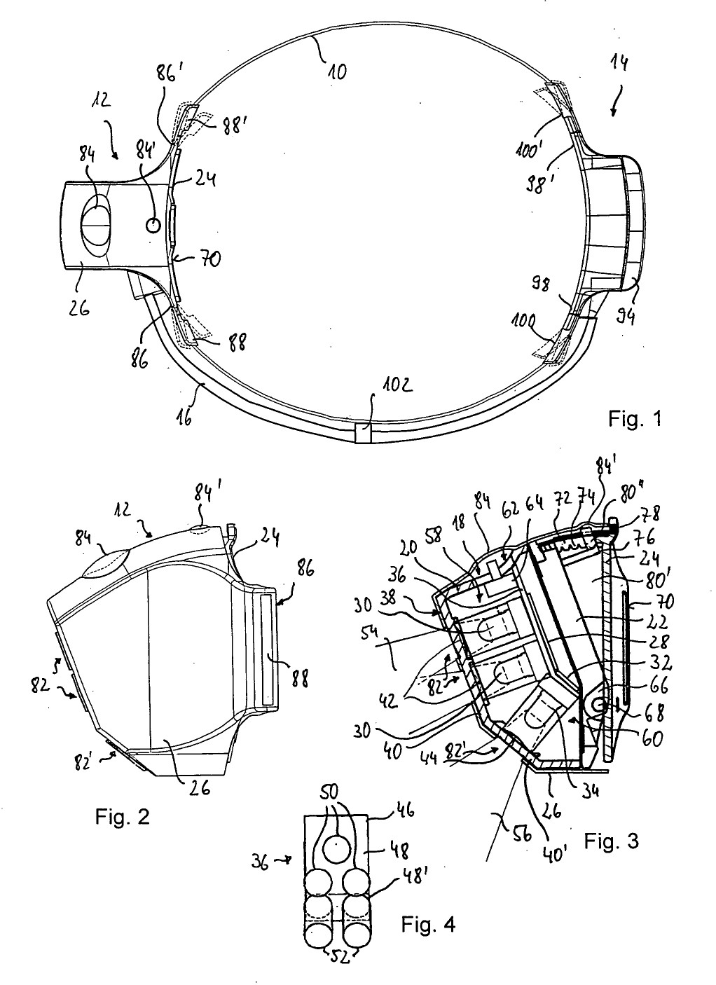

In FIG. 1, a head lamp in accordance with a preferred embodiment of the invention, includes a lamp head 12 held at an elastic, very stretchable headband 10, a battery holder 14 and a connection cable 16 which is likewise held at the headband 10, which connects the battery holder 14 to the lamp head 12 and which serves for the power supply of the lamp head 12 by batteries or rechargeable batteries held in the battery holder 14.

The lamp head 12 shown more precisely in FIGS. 2, 3, 5 and 6 includes a housing 18 termed a light head housing in the following with a housing front part 20 and a housing rear wall 22, a support element 24 pivotably supported at the lamp head housing 18 or at its housing rear wall 22 and a jacket 26 which is open in the region of the housing rear wall 22 and of the support element 24, but otherwise surrounds the lamp head housing 18 and which is termed a lamp head housing jacket in the following.

In the lamp head housing 18, three first light emitting diode elements 30 for white light not visible in all Figures are arranged on a first board 28 and two second light emitting diode elements 34 for white light not visible in all Figures as well as corresponding supply circuits for the light emitting diode elements are arranged on a second board 32. The light emitting diode elements 30 and 34 partly engage into a tube body 36 fastened in the lamp head housing 18.

The housing front part 20 made of a transparent thermoplastic such as polycarbonate has a front wall 38 with an upper planar section 40 and with a lower planar section 40′ which is angled at a pre-determined angle of approximately 45° in the example in the direction of the housing rear wall 22.

In the upper section 40 of the front wall 38, three first converging lenses 42 of the same focal length arranged at the corners of an equilateral triangle are formed and in the lower section 40′ there are furthermore formed two second converging lenses 44 which lie next to one another and whose focal length, which is the same in each case, differs from that of the first converging lenses 42. The optical axes of the first converging lenses 42 extend toward one another with equal, low pre-determined first inclination angles with respect to a perpendicular on the plane of the section 40. In a similar manner, the optical axes of the second converging lenses 44 are inclined toward one another with respectively equal, low pre-determined second inclination angles with respect to a perpendicular, with a plane set up through the optical axes being oriented substantially orthogonally to the plane of the section 40′.

The one-piece tube body 36 (cf. FIG. 4) has a base plate 46 which likewise includes an upper section 48 and a lower section 48′ likewise angled with respect to the upper section 48 by the pre-determined angle, i.e. in the example by approximately 45°. Three first tubes 50 are arranged at the upper section 48 whose longitudinal axes orthogonally to the upper section 40 of the front wall extend through the centers of the corresponding first converging lenses 42 and which contact the front wall 38 when the tube body 36 is inserted into the lamp head housing 18. Two second tubes 52 are arranged on the lower region of the base plate 46 whose longitudinal axes in the installed state of the tube bodies 36 extend orthogonally to the lower section 40′ of the front wall through the centers of the corresponding second converging lenses 42 and which contact the front wall 38.

The first and second tubes 50 and 52 are black and matt at their inner side and have the same length. They each open in corresponding openings in the base plate 46 which form receivers for lamp bodies of the light emitting diode elements 30 and 34 together with the corresponding ends of the tubes 50 and 52. The first board 28 and the second board 32 are fastened to the base plate 46, with the corresponding light emitting diode elements 30 or 34 being arranged in substantially shape matched manner in the corresponding first tubes 50 or second tubes 52 and their longitudinal axes and thus radiation directions being aligned parallel to one another by these.

Light transmitted by the light emitting diode elements 30 and 34 is guided through the corresponding tubes 50 and 52 and the converging lenses 42 and 44 each thus associated with the light emitting diode elements and forms first or second transmitted light beams 54 or 56. The first light emitting diode elements 30 and the first converging lenses 42 as first image producing devices therefore form a first lamp unit 58, whereas the second light emitting diode elements 34 together with the second converging lenses 44 as second image producing devices represent a second lamp unit 60 which is arranged at the pre-determined angle of approximately 45° in the example with respect to the first lamp unit 58.

A switch 64 arranged partly in a switch opening 62 on an upper side of the housing front part 22 forms, together with corresponding circuits on the first board 28 and on the second board 32, a switch device by means of which either only the first light emitting diode elements 30, and thus the lamp unit 58, or only the second light emitting diode elements 34, and thus the lamp unit 60, or also both light emitting diode elements 30 and 34, and thus the lamp units 50 and 60, can be switched on or off together.

The support element 24 is made areally and is pivotably supported (cf. FIGS. 2 and 3 or FIGS. 5 and 6) by means of bearing eyes 66 on corresponding bearing spigots 68 at the housing rear wall 22 of the lamp head housing 18 about a corresponding axis in a plane substantially orthogonal to a plane of the support element.

Furthermore, a contact surface 70 is formed on a side of the support element 24 remote from the lamp head housing 18 and contacts the forehead of a user on the wearing of the head lamp when he has pulled the elastic headband 10 over this head.

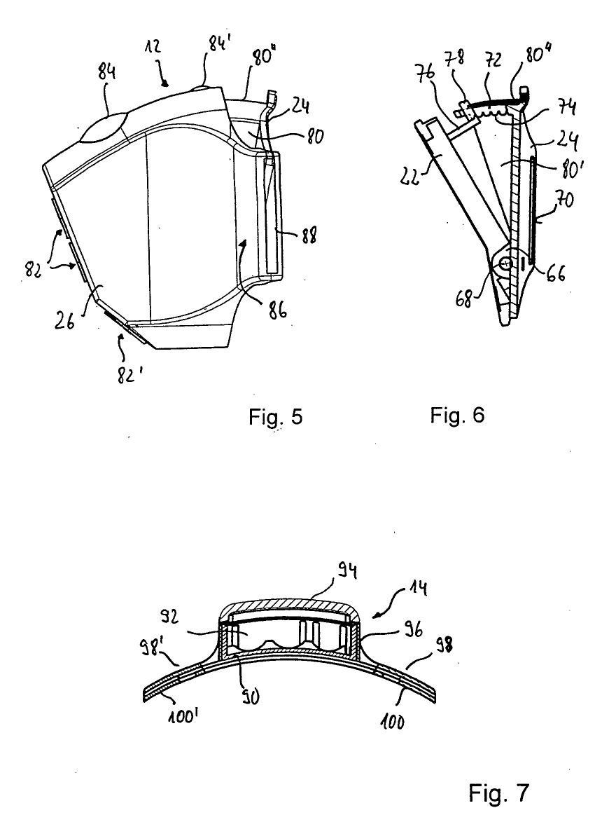

To secure the support element 24 in a set pivot position with respect to the housing rear wall 22, an arched toothed rack 72 of circular segment shape with latch teeth 74 as latch elements is arranged at the support element 24 and a resilient latch arm 76 of hook shape at the free end and with an end projection 78 with a latch opening for the latch teeth 74 as a complementary latch element is arranged at the housing rear wall 22. The toothed rack 72 is arched and arranged relative to the latch arm 76 such that the toothed rack 72 engages through the latch opening in the end projection 78 and a lower edge of the latch opening can be latched by a bias of the resilient latch arm 76 into the gaps between the latch teeth 74. A movement of the support element 24 with respect to the housing rear wall 22 is thus prevented. The resilient latch arm 76 is movable away from the toothed rack 72 by pressure on the end projection 78 with the latch opening such that the toothed rack 72 is displaceable in the latch opening and the support element 24 is pivotable with respect to the housing rear wall 22 (cf. FIGS. 5 and 6).

Furthermore, lateral cover walls 80 and 80′ of circular sector shape and an upper cover wall 80″ are provided at the support element 24 (cf. FIGS. 3 and 6).

The support element 24 furthermore has slots not shown in the Figures through which the ends of the headband 10 can be guided and fastened by folding back and sewing.

The lamp head housing jacket 26 which partly surrounds the lamp head housing 18 is made from a thermoplastic, elastomeric material, e.g. from a corresponding polyurethane polymer. Openings 82 and 82′ corresponding to the first and second converging lenses 42 or 44 are formed at a region of the lamp head housing jacket 26 contacting the front wall 38 such that light can be radiated through them. Except for these openings 82 and 82′ and an opening in the region of the support element 24, the lamp head housing jacket 26 completely surrounds the housing 18.

The lamp head housing jacket 26 extends beyond the housing rear wall 22 up to a peripheral outer rim of the support element 24 when this is pivoted toward the housing rear wall 22. The cover walls 80, 80′ and 89″ are shaped such that, together with the lamp head housing jacket 26, they substantially cover a hollow space formed between the support element 24 and the housing rear wall 22 (cf. FIGS. 2 and 5). The end faces of the lateral cover walls 80 and 80′ contact the housing rear wall 22 when the support element 24 is pivoted toward the housing rear wall 22 (cf. FIG. 3).

Since the lamp head housing jacket 26 is made from an elastomeric material, the switch 64 and the end projection 78 with the latch opening can be operated through corresponding bucklings 84 and 84′.

The lamp head housing jacket 26 furthermore serves for the sealing of the lamp head housing 18 since it contacts this tightly and thus largely prevents a penetration of water between the lamp head housing jacket 26 and the lamp head housing 18. No water can also thereby penetrate between the housing front part 20 and the housing rear wall 22 or through the switch opening 62 into the interior of the lamp head housing 18.

Furthermore, the lamp head housing jacket 26 continues to the side of the lamp head housing 18 into two flexible lugs 28 and 86′ which each have loops 88 and 88′ at their ends with slot-shaped openings whose height corresponds to the width of the headband 10 and through which the headband 10 can be guided. The lugs 86 and 86′ are so flexible (cf. FIG. 1) that they can be pulled toward the head and contact it by pulling at the headband 10 such as occurs when the head lamp is put onto a head. A comparatively large contact surface of the head lamp in accordance with the invention is thereby produced, whereby pressure points are avoided, on the one hand, and a particularly secure seat is ensured, on the other hand, due to the large contact area also extending far to the sides.

The battery holder 14 shown more precisely in FIG. 7 has a housing made of a thermoplastic with a battery housing lower part 90 with a battery compartment 92 and with a battery holder cover 94 pivotably connected to the battery housing lower part 90. The battery housing lower part 90 is partly surrounded in an analog manner to the lamp head housing 18 of the lamp head 12 in a jacket 96 made of an elastomeric thermoplastic materials, termed a battery housing jacket in the following, which, like the lamp head housing jacket 26, has two lugs 98 and 98′ at whose free ends loops 100 and 100′ are provided for the reception of the headband 10 which are formed like the loops 86 and 86′. A rim of the battery housing jacket 96 remote from the battery holder cover 94 simultaneously serves as a seal for the sealing of a possibly occurring gap between the battery housing lower part 90 and the battery holder cover 94.

The free ends of the lugs 86 and 84′ or 98 and 98′ each have a spacing of approximately 8 cm from one another such that a spacing of approximately 4 cm results to the center of the support element 24 or of the battery holder housing. Torques between a head wearing the head lamp and the lamp head housing 18 or the battery holder housing, for example due to a fast head movement, can therefore not only be transmitted over the contact surface 70 or over a corresponding surface of the battery holder housing, but also over the lugs 86 and 86′ or 98 and 98′, in particular via their sections contacting the head, with only low forces occurring at their ends or at the loops 88 and 88′ or 100 and 100′ due to the comparatively long lever arms formed by the lugs 86 and 96′ or 98 and 98′, which can be transmitted by only light pressure by the headband 10 between the head and the lamp head 12. The head lamp therefore has a particularly secure seat.

The connection cable 16 shown only schematically in FIG. 1 and held at the headband 10 via a clamping holder 102 has two wire which are connected to corresponding poles of the battery compartment 92 in the battery holder 14 and which are connected to corresponding contacts on the first and second boards 28 and 32. The connection cable 16 can in particular have a coiled part region such that the battery holder is displaceable at the headband 10.

For the manufacture of the lamp head 12, the housing front part 20 together with the lamp head housing jacket 26 and the battery housing lower part, including the battery holder cover 94 formed in one piece therewith and together with the battery housing jacket 96, can be manufactured by two-component injection molding. A tight shape matched arrangement hereby results with the exception of the bucklings 84 and 84′—depending on the materials used also a certain material matched arrangement —between the lamp head housing jacket 26 and the lamp head housing 18 or the battery housing lower part 90 and the battery housing jacket 96, which ensures a very good force transmission between these components and a good sealing between these components against penetrating moisture.

The tube body 36 can thereafter be inserted into the housing front part 20 and fastened therein, whereupon the first and second boards 28 and 32 with the first light emitting diode elements 30 or the second light emitting diode elements 34 are pushed into the base plate 46 with the tubes 50 or 52 and fastened to the base plate 46. The housing rear wall 22 with the support element 24 held thereat can then be screwed to the housing rear wall 22.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A head lamp comprising
a lamp head (12) for the reception of a light source (30, 34) the lamp head (12) having two lugs (86, 86′) arranged at opposite sides and connected to it, and to which an elastic headband (10) of the head lamp can be fastened for the fastening of the head lamp to the head of a person and which are so flexible that their shape is adaptable to the shape of the head by the tension of the headband (10) on being secured to the head.

2. A head lamp in accordance with claim 1, characterized in that a battery holder (14) is provided with two lugs (98, 98′) arranged at opposite sides of the battery holder (14) and connected thereto, to which the headband (10) can be fastened and which are so flexible that their shape is adaptable to the shape of the head by the tension of the headband (10) on being secured to the head.

3. A head lamp in accordance with claim 1, characterized in that the lugs (86, 86′, 98, 98′) each have slot-shaped openings (88, 88′, 100, 100′) through which the headband (10) can be guided.

4. A head lamp in accordance with claim 1, characterized in that the lamp head (12) and/or the battery holder (14) has a housing (18, 90) which is at least partly surrounded by a jacket (26, 96) made of an elastic material at which the lugs (86, 86′, 98, 98′) are formed.

5. A head lamp in accordance with claim 4, characterized in that the jacket (26, 96) is made from an elastomeric material.

6. A head lamp in accordance with claim 5, characterized in that the jacket (26, 96) is made of a thermoplastic, elastomeric material and the housing (18, 80) is made from a further thermoplastic material.

7. A head lamp in accordance with claim 4, characterized in that a switch (64) is arranged in the housing (18) which is covered by the jacket (26) and can be operated by pressure on the jacket (26).

8. A head lamp in accordance with claim 4, characterized in that at least one lens (42, 44) is formed in a wall (38) of the housing (18) of the lamp head (12) as an image producing device for the formation of a light beam (54, 56), which can be transmitted by the lamp head (12), from light of a light source (30, 34) held in the lamp head (12); and in that a corresponding opening (82, 82′) is provided in the jacket (26).

9. A head lamp in accordance with claim 1, characterized in that the lamp head (12) has a housing (18) for the reception of at least one light source (30, 34) and an areal support element (24) held at the housing (18) which is pivotable relative to the housing (18) in a plane which is aligned substantially orthogonally to a surface of the support element (24).

10. A head lamp in accordance with claim 9, characterized in that latch elements (72, 74, 76, 78) complementary to one another and by means of which the support element (24) is securable in its relative position to the housing (18) are arranged at the housing (18) and at the support element (24).

11. A head lamp in accordance with claim 10, characterized in that one of the latch elements (76, 78) can be moved by pressure onto a pre-determined region of the jacket (26) of the lamp head (12) and the latching of the latch elements (72, 74, 75, 78) can thus be cancelled.

12. A method for the manufacture of a housing and of a corresponding jacket for a head lamp,
wherein the housing (18, 90) and the jacket (26, 96) are manufactured by two-component injection molding of a thermoplastic, elastomeric material and of a further thermoplastic material.
